(19) United States
(12) Patent Application Publication
(10) Pub. No.: US 2026/0118222 A1
(43) Pub. Date: Apr. 30, 2026

(54) CONTROL DEVICE AND METHOD FOR MEASURING AN INTERNAL COMBUSTION ENGINE ON A TEST BENCH

(71) Applicant: Rolls-Royce Solutions GmbH, Friedrichshafen (DE)

(72) Inventor: Daniel Bergmann, Bad Waldsee (DE)

(73) Assignee: Rolls-Royce Solutions GmbH, Friedrichshafen (DE)

(21) Appl. No.: 19/371,501

(22) Filed: Oct. 28, 2025

Related U.S. Application Data
(63) Continuation of application No. PCT/EP2024/061312, filed on Apr. 24, 2024.

(30) Foreign Application Priority Data
Apr. 28, 2023 (DE) 10 2023 111 107.8
Apr. 24, 2024 (WO) PCT/EP2024/061312

(51) Int. Cl. G01M 15/05; F02D 41/22

(52) U.S. Cl. CPC G01M 15/05; F02D 41/22; F02D 2041/224

(57) ABSTRACT

A control device for measuring an internal combustion engine on a test bench includes: at least one interface, which is configured to receive a measured value measured at a measurement point of a parameter space of the internal combustion engine, spanned by at least one internal combustion engine parameter; a computing module, which is configured to adapt an internal combustion engine model based on the measured value—which is received—at the measurement point; and an optimization module, which is configured to determine a target function based on an adapted internal combustion engine model, to optimize the target function, and based on the target function—which is optimized—to determine a new measurement point in the parameter space.

### CROSS REFERENCE TO RELATED APPLICATIONS

This is a continuation of PCT application no. PCT/EP2024/061312, entitled “CONTROL DEVICE AND METHOD FOR MEASURING AN INTERNAL COMBUSTION ENGINE ON A TEST BENCH”, filed Apr. 24, 2024, which is incorporated herein by reference. PCT application no. PCT/EP2024/061312 claims priority to German patent application no. 10 2023 111 107.8, filed Apr. 28, 2025, which is incorporated herein by reference.

### BACKGROUND OF THE INVENTION

### 1. Field of the Invention

The present invention relates to internal combustion engines.

### 2. Description of the Related Art

It is known that an internal combustion engine is measured on a test bench before use in order to create an internal combustion engine model for the operation of the internal combustion engine. In particular, the internal combustion engine is thereby operated automatically or manually according to a measurement plan. The measurement plan includes, in particular, values of at least one input parameter of the internal combustion engine, which defines a parameter space for the internal combustion engine, for example introduction time for introducing, in particular atomizing or injecting, a fuel, an introduction volume of the fuel, an introduction pressure, an air supply, an exhaust gas discharge, and valve control times for gas exchange valves, in particular intake and exhaust valves, such as for example a valve opening time and a valve closing time.

Typically, the internal combustion engine is operated in accordance with the measurement plan and calibrated on the basis of the measurement data obtained in such a way that the lowest possible fuel consumption is achieved for a given emission level, in particular in accordance with legal guidelines.

The measuring plan is generated in particular, in such a way that a time on the test bench—and thus the costs for parameterization of the internal combustion engine—are minimized. A disadvantage of this is that the measurement plan is developed before the measurement begins and therefore cannot be adjusted during the measurement based on the measured values already obtained, or can only be adjusted with considerable effort and, in particular, manual intervention. This makes it difficult in practice to adaptively reduce the number of measurement points and thus reduce the measurement costs.

What is needed in the art is a control device and a method for measuring an internal combustion engine on a test bench, wherein the aforementioned disadvantages are reduced and optionally do not occur.

### SUMMARY OF THE INVENTION

The invention relates to a control device for measuring an internal combustion engine on a test bench.

The present invention provides a control device for measuring an internal combustion engine on a test bench. The control device has at least one interface, one computing module and an optimization module. The at least one interface is arranged to receive a measurement value measured at a measurement point of a parameter space of the internal combustion engine, spanned by at least one internal combustion engine parameter. The computing module is arranged to adapt an internal combustion engine model based on the received measured value at the measurement point. In addition, the optimization module is arranged to determine a target function based on the adapted internal combustion engine model, to optimize the target function, and to determine a new measurement point in the parameter space based on the optimized target function. The control device advantageously considers objectives of the operation of the internal combustion engine systematically and, in particular, automatically by optimizing the target function. By no longer rigidly pre-determining the measurement points—with the exception of an initial, first measurement point—but rather generating them dynamically during the measurement duration, taking into account the operating objectives such as, in particular, minimal fuel consumption while complying with legal emissions, it is advantageously possible by way of the control device to increase the model quality of the internal combustion engine model compared to the state of the art and at the same time to reduce, in particular halve, the number of measurement points for determining the internal combustion engine model compared to the state of the art. Such a reduction in the number of measurement points is possible in particular because, due to their dynamic generation, considering the operating objectives, at least essentially relevant measurement points are approached, whereas a measurement plan prepared in advance consults the parameter space without sufficient prior knowledge, so that a large number of measurement points must be approached in order to capture at least a sufficient number of relevant measurement points. With the control device according to the invention, it is thus advantageously possible to reduce the time and in particular the costs for measuring the internal combustion engine compared to the prior art, in particular to halve them, and to carry out the measurement, for example, within a few weeks.

In the context of the present technical teaching, a module is generally understood to mean, in particular, an intellectually or physically definable or distinct functional unit arranged to perform at least one specific function. This may be a separate computing device, a part of a computing device, a hardware structure, or a software structure, each arranged and intended to fulfill the at least one specific function.

In the context of the present technical teaching, an interface is understood in particular to be a functional unit that is arranged to receive and/or transmit data. In one embodiment, the at least one interface is part of a communication module of the control device, or the control device has a communication module which consists of the at least one interface. The interface can be a wired or wireless interface, in particular a serial or parallel interface, in particular a USB interface, a LAN interface, or WLAN interface, or an interface for exchanging mobile data. The interface may also be arranged to read data from an external storage device or read/write device integrated into the control device, or to write data to the storage device or read/write device. It is possible for such a read/write device to only be able to write or read. In particular, it is possible for the control device to have a first read/write device that can only write, and a second read/write device that can only read. However, it is also possible for the control device to have at least one read/write device that can both write and read.

In the context of the present technical teaching, the optimization of a function, in particular the target function, is understood to mean, in particular, the determination of an extremum of the function. In the context of the present technical teaching the optimization of a function, in particular the target function, furthermore includes, in particular, the determination of a minimum and/or a maximum of the function.

The optimization module is arranged in particular, to determine an extremum, in particular a maximum and/or a minimum, of the target function. In particular, the optimization module is arranged to maximize and/or minimize the target function.

In particular, the at least one interface is additionally arranged to communicate the new measurement point to the internal combustion engine for measuring a new measured value in the new measurement point.

The control device—in particular the at least one interface, the computing module, and the optimization module—is arranged in particular to use at least one internal combustion engine input parameter spanning the parameter space as a measurement point, which is selected from a group consisting of an introduction time for introducing, in particular atomizing or injecting of a fuel, an introduction volume of the fuel, an introduction pressure, a fresh air mass flow, and valve timing for gas exchange valves, in particular intake and exhaust valves, such as a valve opening time and a valve closing time, an internal combustion engine speed, and a combination of the aforementioned parameters. Alternatively, or additionally, the control device—in particular the at least one interface, the computing module, and the optimization module—is arranged to use at least one internal combustion engine output parameter as a measured value, which is selected from a group consisting of a fuel consumption, an emission volume, a combustion chamber pressure, and a combination of the aforementioned parameters.

The control device is optionally arranged to iteratively adapt the internal combustion engine model based on the new measurement point and to determine a further new measurement point in the parameter space.

In the context of the present technical teaching, an emission volume is in particular a concentration of a predetermined emission substance and/or an emission substance class, in particular in a unit mass per exhaust gas volume or ppm. Alternatively, or in addition, an emission volume is an output of the predetermined emission substance and/or the emission substance class per time unit. In particular, the predetermined emission substance and/or a substance of the emission substance class is solid, in particular a particle, or liquid or gaseous. In particular, the emission substance and/or the emission substance class is selected from a group consisting of carbon monoxide, carbon dioxide, hydrocarbons, in particular polycyclic aromatic hydrocarbons, soot particles, nitrogen oxides, in particular nitrogen monoxide and/or nitrogen dioxide, and sulfur oxides, in particular sulfur dioxide.

The control device is arranged in particular, to operate the internal combustion engine. The control device is optionally arranged to operate the internal combustion engine at an operating measurement point as the measurement point. Alternatively, or additionally, the control device is arranged to operate the internal combustion engine at the new measurement point. In the context of the present technical teaching, operating the internal combustion engine is understood to mean, in particular, controlling or regulating, optionally regulating, the operation of the internal combustion engine.

In the context of the present technical teaching, the at least one internal combustion engine input parameter, in particular the plurality of internal combustion engine input parameters, spans the parameter space from which the measurement points are selected. Moreover, the measured values are spanned over the parameter space, in particular using the internal combustion engine model.

According to a further development of the invention, the computing module is additionally arranged to use a Gaussian process model as the internal combustion engine model. Gaussian process models are particularly suitable for developing an internal combustion engine model: compared to polynomial-based models, they are easier to adapt to new or changed data points in the field of application, and they exhibit more suitable and physically correct behavior in boundary regions of the existing parameter space. Compared to physical models, they require significantly less computational effort. Furthermore, they enable the direct use of test bench data. Such a Gaussian process model is constructed and/or refined in particular using measured values Y_{b} at measurement points X_{b}, wherein X_{b}ϵ [symbol] denotes in particular n input parameters, in particular internal combustion engine input parameters, for m different measurement points, and Y_{b}ϵ [symbol] denotes in particular k output parameters, in particular internal combustion engine output parameters, for the m different measurement points. In one embodiment, m=1 applies in a first step, where m is increased by 1 in each iteration step of the measurement of the internal combustion engine. In an alternative embodiment, a basic grid of the Gaussian process model, in particular m measurement points and associated measured values, is known, and based on new additional measured values, the basic grid of the Gaussian process model is refined and/or adapted, where m is increased by 1 in each iteration step of the measurement of the internal combustion engine. Furthermore, the Gaussian process model is characterized by a predetermined calculation scheme for an expected value E(Xᵤ)ϵ [symbol] and a variance Var(Xᵤ) for measurement points not contained in the original data set for l different operating states Xᵤϵ [symbol] [symbol] :

$$E ( {X}_{u} ) = K ( {X}_{u} , {X}_{b} ) {( K ( {X}_{b} , {X}_{b} ) )}^{- 1} {Y}_{b} , \qquad ( 1 )$$

$$Var ( {X}_{u} ) = \sqrt{K ( {X}_{u} , {X}_{u} ) - K ( {X}_{u} , {X}_{b} ) {( K ( {X}_{b} , {X}_{b} ) )}^{- 1} K ( {X}_{b} , {X}_{u} ) ,} \qquad ( 2 )$$

with a covariance function K, which depends in the following manner on the Euclidean distance r between two points xᵣ, xₛ.

$$K ( {X}^{r} , {X}^{s} ) = {( k ( {X}_{1 : n , i}^{r} , {X}_{1 : n , j}^{s} ) )}_{i = 1 , j = 1 , … , j = 1 , … , m} , \qquad ( 3 )$$

$$k ( {x}_{r} , {x}_{s} ) = {σ}_{F}^{2} exp ( - \frac{{r ( {x}_{r} , {x}_{s} )}^{2}}{2 {l}^{2}} ) + {δ}_{r , s} {σ}_{N}^{2} , \qquad ( 4 )$$

with a predetermined distance parameter l—in particular a width of a Gaussian bell—, a predetermined signal variance σ_{F}—in particular a predetermined signal swing—, a predetermined measurement noise σ_{N} and a Kronecker delta δ_{r,s}. In particular, δ_{r,s}=0 for two different points xᵣ, xₛ and δ_{r,s}=1 for two identical points xᵣ, xₛ, wherein function K is not zero at identical points xᵣ, xₛ and thus advantageously a numerical calculation becomes more stable, in particular a numerical calculation of an inverse becomes more stable. Thus, in equations (1) and (2) K(Xᵤ, X_{b})ϵ [symbol] , K(X_{b}, X_{b})ϵ [symbol] , Iϵ [symbol] and Y_{b}ϵ [symbol] . In particular, expected value E(Xᵤ) has a fuel consumption expected value. Alternatively, or additionally, expected value E(Xᵤ) has an emissions expected value. Alternatively, or additionally, expected value E(Xᵤ) has a combustion chamber pressure expected value. In particular, variance Var(Xᵤ) has a fuel consumption variance. Alternatively, or additionally, variance Var(Xᵤ) has an emissions variance. Alternatively, or additionally, variance Var(Xᵤ) has a combustion chamber pressure variance.

According to a further development of the invention, the computing module is also arranged to determine a fuel consumption distribution, in particular based on the at least one internal combustion engine input parameter. Alternatively, or additionally, the computing module is arranged to determine an emissions distribution, in particular via the at least one internal combustion engine input parameter. Advantageously, based on fuel consumption and/or emissions of the internal combustion engine, it is possible to optimally adjust the internal combustion engine with regard to legal regulations.

In the context of the present technical teaching, a fuel consumption distribution is understood to be a probability distribution of the fuel consumption of the internal combustion engine over the parameter space of the internal combustion engine. Moreover, an emissions distribution in the context of the present technical teaching is understood to be a probability distribution of the volume of emissions of the internal combustion engine over the parameter space of the internal combustion engine.

In particular, the computing module is arranged to determine the fuel consumption expected value and the fuel consumption variance of the fuel consumption distribution. Alternatively, or additionally, the computing module is arranged to determine the emission expected value and the emission variance of the emission distribution.

According to a further development of the invention, the optimization module is also arranged to determine the target function depending on the fuel consumption distribution. Alternatively, or additionally, the optimization module is arranged to determine the target function depending on the emissions distribution. In particular, points exhibiting a large fuel consumption variance and/or a large emissions variance are specifically searched for in the parameter space of the internal combustion engine in order to measure these points as measurement points and thereby reduce the fuel consumption variance and/or the emissions variance at this measurement point, in particular to a minimum value. This makes it advantageously possible to predict the fuel consumption and/or emissions at the measurement point with greater certainty. In particular, the smaller the variances and/or uncertainties, the better the internal combustion engine model.

The optimization module is arranged to determine target function J in formula

$$J = {J}_{V}$$

where J_{V} denotes a fuel consumption target function. In particular, the optimization module is arranged to determine the fuel consumption target function J_{V} using at least one of the following equations

$${J}_{V} = {J}_{V , σ} = - {σ}_{V} \qquad ( 5 )$$

$${J}_{V} = {J}_{V , μ} = {μ}_{V} - {σ}_{V} \qquad ( 6 )$$

$${J}_{V} = {J}_{V , σ} + {J}_{V , μ} = {μ}_{V} - 2 {σ}_{V} \qquad ( 7 )$$

wherein σ_{V} denotes a fuel consumption variance of the fuel consumption distribution and μ_{V} denotes an expected fuel consumption value of the fuel consumption distribution. Based on the target function according to equation (5), a point is selected as the new measurement point which has a large fuel consumption variance, so that the fuel consumption variance of the internal combustion engine model is advantageously reduced after each measurement step, thereby achieving better knowledge of the internal combustion engine model. Based on the target function according to equation (6), a point is selected as the new measurement point which has a potentially low fuel consumption. Alternatively, or additionally, the optimization module is arranged to determine the target function J in formula

$$J = {J}_{E}$$

wherein J_{E} denotes an emission target function. In particular, the optimization module is arranged to determine the emission target function J_{E} using at least one of the equations

$${J}_{E} = {J}_{E , 1} = max ( 0 , {μ}_{E} + {σ}_{E} - {NOx}^{+} ) \qquad ( 8 )$$

$${J}_{E} = {J}_{E , 2} = max ( 0 , - ( {μ}_{E} + {σ}_{E} ) + {NOx}^{-} ) \qquad ( 9 )$$

$${J}_{E} = {J}_{E , 1} + {J}_{E , 2} \qquad ( 10 )$$

wherein σ_{E} denotes an emission variance of the emission distribution, μ_{E} denotes an emission expectation value of the emission distribution, NOx⁺ denotes a maximum emission, NOx⁻ denotes a minimum emission defined with regard to the efficiency. Potentially exceeding the maximum emission is penalized based on the target function according to equation (8), so that a point is selected as the measurement point whose potential emission is below the maximum emission. Potentially dropping below the minimal emission is penalized based on the target function according to equation (9), so that a point is selected as the measurement point whose potential emission is above the minimum emission. Alternatively, or additionally, the optimization module is arranged to determine target function J in formula

$$J = {J}_{V} + {J}_{E} \qquad ( 11 )$$

wherein the fuel consumption target function J_{V} and the emission target function J_{E} are selected from one of the previous equations. Optionally, the optimization module is arranged to determine target function J in formula

$$J = {J}_{V , σ} + {J}_{V , μ} + {J}_{E , 1} + {J}_{E , 2} = {μ}_{V} - 2 {σ}_{V} + max ( 0 , {μ}_{E} + {σ}_{E} - {NOx}^{+} ) + max ( 0 , - ( {μ}_{E} + {σ}_{E} ) + {NOx}^{-} ) \qquad ( 12 )$$

Particularly optionally, the optimization module is arranged to determine target function J in formula

$$J = {a}_{1} \cdot {J}_{V , σ} + {a}_{2} \cdot {J}_{V , σ} + {a}_{3} \cdot {J}_{E , 1} + {a}_{4} \cdot {J}_{E , 2} \qquad ( 13 )$$

wherein aᵢ denotes factors for weighting and/or normalizing the individual sub-target functions. Based on the target functions according to equations (11) to (13), the objectives regarding knowledge of the internal combustion engine model, minimization of fuel consumption, and compliance with minimum and maximum emissions are combined.

According to a further development of the invention, the optimization module is also arranged to optimize the target function by considering at least one secondary condition. This makes it possible to incorporate limits for the operation of the internal combustion engine into the optimization and thus the determination of the new measurement point.

According to a further development of the invention, the optimization module is also arranged to determine the at least one secondary condition based on at least one parameter selected from a group consisting of a combustion chamber pressure, a combustion chamber pressure gradient, a compressor surge, a soot formation, and a combination of the preceding parameters.

The optimization module is optionally arranged to determine the secondary condition based on a combustion chamber pressure. In particular, the optimization module is arranged to determine the secondary condition in formula

$$P ( {p}_{max} > {p}_{max}^{max} ) < {p}^{*}$$

where P(⋅) denotes a target function, pₘₐₓ a combustion chamber pressure maximum occurring during a temporal combustion process,

$${p}_{max}^{max}$$

a maximum permissive combustion chamber pressure, and p* a predetermined limiting probability. In particular, the optimization module is arranged to establish the predetermined limiting probability as p*=0.25. This advantageously ensures for the new measurement point that the probability that the combustion chamber pressure maximum is greater than the maximum permissible combustion chamber pressure is less than p*, in particular less than 25%.

In particular, the control device is arranged to carry out the method according to the invention explained below or a method according to one or more of the embodiments explained below. In particular, the description of the control device, on the one hand, and the method, on the other, are to be understood as complementary.

The present invention provides a method for measuring an internal combustion engine on a test bench, wherein the control device according to the invention or a control device according to one of the previously described embodiments is used to implement the method. The internal combustion engine is thereby a) operated and measured at an operating measurement point, wherein b) a measured value is obtained. Subsequently c) an internal combustion engine model is adapted based on the measured value at the operating measurement point. d) A target function is determined based on the adapted internal combustion engine model. e) The target function is optimized, wherein a new measurement point is obtained based on the optimized target function. Advantages arise in connection with the method which were already explained in connection with the control device.

In particular, the method includes at least one step, optionally a combination of steps, which were previously described explicitly or implicitly in connection with the control device. In particular, the method is an operating method of the control device, in particular for performing the functions described above.

In particular, at least one internal combustion engine input parameter spanning the parameter space of the internal combustion engine is used as the operating measurement point and/or as the new measurement point, which is selected from a group consisting of an introduction time for introducing, in particular injecting or injection of a fuel, an introduction volume of the fuel, an introduction pressure, a fresh air mass flow, and valve timing for gas exchange valves, in particular intake and exhaust valves, such as in particular a valve opening time and a valve closing time, an internal combustion engine speed, and a combination of the aforementioned parameters. Alternatively, or in addition, at least one internal combustion engine output parameter, selected from a group consisting of a fuel consumption, an emission volume, a combustion chamber pressure, and a combination of the aforementioned parameters is used as the measured value.

A further development of the invention provides that f), steps a) to e) are repeated with the new measurement point now being the operational measurement point until a termination condition is reached.

In particular, an initial operating measurement point is specified and/or determined using a state-of-the-art measurement plan according to the invention. Originating from the initial operating measurement point, the process is then carried out, especially iteratively, until the termination condition is reached.

A further development of the invention provides that a Gaussian process model is used as the internal combustion engine model.

A further development of the invention provides that a fuel consumption distribution is determined using the internal combustion engine model. Alternatively, or in addition, an emissions distribution is determined by using the internal combustion engine model. Based on a fuel consumption and/or an emission of the internal combustion engine, it is advantageously possible to optimally adjust the internal combustion engine with regard to legal regulations.

In particular, based on the internal combustion engine model a fuel consumption expectation and a fuel consumption variance of the fuel consumption distribution are determined by way of the internal combustion engine model. Alternatively, or additionally, an emission expectation and an emission variance of the emission distribution are determined based on the internal combustion engine model.

A further development of the invention provides that the target function is determined depending on the fuel consumption distribution. Alternatively, or additionally, the target function is determined depending on the emissions distribution.

In particular, target function J is determined in formula J=J_{V}
wherein J_{V} denotes a fuel consumption target function. In particular, fuel consumption target function J_{V} using one of the equations (5) to (7). Alternatively, or additionally, target function J is expressed in formula J=J_{E}
wherein J_{E} denotes an emission target function. In particular, emission target function J_{E} is determined by using one of the equations (8) to (10). Alternatively, or additionally, target function J is determined using one of the equations (11) to (13).

A further development of the invention provides that the target function is optimized by considering at least one secondary condition. The at least one secondary condition is determined based on at least one parameter selected from a group consisting of a combustion chamber pressure, a combustion chamber pressure gradient, a compressor surge, a soot formation, and a combination of the preceding parameters. This makes it advantageously possible to incorporate limits for the operation of the internal combustion engine and thus the determination of the new measurement point into the optimization.

The secondary condition is optionally determined based on a combustion chamber pressure. The secondary condition is determined in particular in formula

$$P ( {p}_{max} > {p}_{max}^{max} ) < {p}^{*}$$

wherein P(⋅) denotes a probability function, pₘₐₓ denotes a combustion chamber pressure maximum occurring during a temporal combustion process,

$${p}_{max}^{max}$$

denotes a maximum permissible combustion chamber pressure, and p* denotes a predetermined limiting probability. In particular, the predetermined limiting probability is specified as p*=0.25. This advantageously ensures for the new measurement point that a probability that the combustion chamber pressure maximum is greater than the maximum permissible combustion chamber pressure is less than p*=0.25, in particular less than 25%.

A further development of the invention provides that as the termination criterion in f) the reaching of a maximum number of new measurement points is used. In particular, steps a) to e) are repeated with the respective new measurement point being the operating measurement point until the maximum number of new measurement points is reached. Alternatively, or additionally, reaching a predetermined measurement point density in the parameter space of the internal combustion engine is used in the termination criterion in f), wherein in particular a) to e) are repeated with the respective new measurement point as the operating measurement point until the predetermined measurement point density is reached. Alternatively, or additionally, a minimum measurement point distance is used as the termination criterion, wherein in particular a) to e) are repeated with the respective new measurement point as the operating measurement point until a distance, in particular a Euclidean distance, between the new measurement point and any of the other measurement points is less than the minimum measurement point distance. Alternatively, or additionally, a maximum variance is used as the termination criterion, wherein in particular a) to e) are repeated with the respective new measurement point being the operating measurement point until the variance of the internal combustion engine model in the embodiment of a Gaussian process model is less than the maximum variance.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic representation of a design example of a control device for measuring an internal combustion engine on a test bench; and

FIG. 2 is a schematic representation of a design example of a method for measuring the internal combustion engine on the test bench.

Corresponding reference characters indicate corresponding parts throughout the several views. The exemplifications set out herein illustrate at least one embodiment of the invention, and such exemplifications are not to be construed as limiting the scope of the invention in any manner.

### DETAILED DESCRIPTION OF THE INVENTION

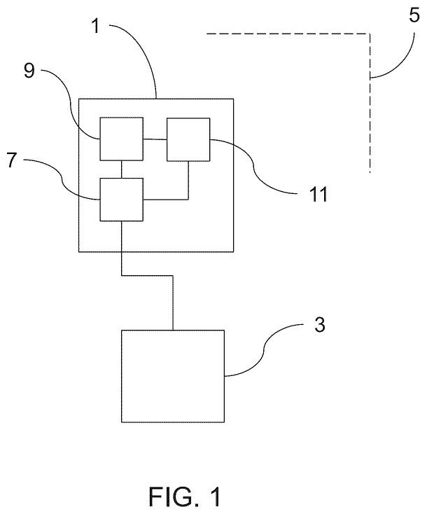

FIG. 1 is a schematic representation of a design example of control device 1 for measuring internal combustion engine 3 on test bench 5. Control device 1 has at least one interface 7, a computing module 9, and an optimization module 11. In particular, the at least one interface 7, computing module 9, and optimization module 11 are connected to one another, in particular in a data transmitting manner.

The at least one interface 7 is arranged to receive a measured value 15 measured at a measurement point 13 of a parameter space of internal combustion engine 3, spanned by at least one internal combustion engine parameter, in particular at least one internal combustion engine input parameter. In particular, the at least one interface 7 is also arranged to communicate to internal combustion engine 3 a new measurement point 21 for measuring a new measured value 15 at new measurement point 21. In particular, the at least one interface is part of a communication module of control device 1, or the communication module consists of the at least one interface. This can be a wired or wireless interface, in particular a serial or parallel interface, in particular a USB interface, a LAN interface, or WLAN interface, or an interface for exchanging mobile data. The interface can also be configured to read data from a storage device or read/write device that is external or integrated into the control device, or to write data to the storage device or read/write device. It is possible for such a read/write device to be capable of either writing or reading. In particular, it is possible for the control device to have a first read/write device that can only write, and a second read/write device that can only read. However, it is also possible for the control device to have at least one read/write device that can both write and read.

Computing module 9 is arranged to adapt an internal combustion engine model 17 based on received measured value 15 at measurement point 13. In particular, computing module 9 is additionally arranged to use a Gaussian process model as internal combustion engine model 17. Alternatively, or additionally, computing module 9 is arranged in particular to determine a fuel consumption distribution 23 and/or an emissions distribution 25, in particular via the at least one internal combustion engine input parameter. In particular, computing module 9 is arranged to determine a fuel consumption expectation value and a fuel consumption variance of fuel consumption distribution 23. Alternatively, or additionally, computing module 9 is arranged in particular to determine an emissions expectation value and an emissions variance of emissions distribution 25.

Optimization module 11 is arranged to determine a target function J based on adapted internal combustion engine model 19, to optimize target function J, and to determine new measurement point 21 in the parameter space based on optimized target function J. In particular, optimization module 11 is also arranged to determine target function J depending on fuel consumption distribution 23. Alternatively, or additionally, optimization module 11 is arranged in particular to determine target function J depending on emission distribution 25. In particular, optimization module 11 is arranged to determine target function J in formula

$$J = {J}_{V}$$

wherein J_{V} denotes a fuel consumption target function. In particular, optimization module 11 is arranged to determine fuel consumption objective function J_{V} using one of the equations (5) to (7). Alternatively, or additionally, optimization module 11 is arranged to determine target function J in formula

$$J = {J}_{E}$$

wherein J_{E} denotes an emissions target function. In particular, optimization module 11 is arranged to determine emissions target function J_{E} based on one of the equations (8) to (10). Alternatively, or additionally, optimization module 11 is arranged to determine target function J based on one of the equations (11) to (13). Alternatively, or additionally, optimization module 11 is arranged in particular to optimize the target function by considering at least one secondary condition. Alternatively, or additionally, optimization module 11 is arranged in particular to determine the at least one secondary condition based on at least one parameter selected from a group consisting of a combustion chamber pressure, a combustion chamber pressure gradient, compressor surge, a soot formation, and a combination of the preceding parameters. Optimization module 11 is optionally arranged to determine the secondary condition based on a combustion chamber pressure. In particular, the optimization module 11 is arranged to determine the secondary condition in formula

$$P ( {p}_{max} > {p}_{max}^{max} ) < {p}^{*}$$

wherein P(⋅) denotes a probability function, pₘₐₓ denotes a combustion chamber pressure maximum occurring during a temporal combustion process,

$${p}_{max}^{max}$$

denotes a maximum permissible combustion chamber pressure, and p* denotes a predetermined limiting probability. In particular, the optimization module 11 is arranged to set the predetermined limiting probability as p*=0.25.

Control device 1—especially the at least one interface 7, computing module 9 and optimization module 11—is arranged to use as a measurement point 13 at least one internal combustion engine input parameter spanning the parameter space, which is selected from a group consisting of an introduction time for introducing, in particular atomizing or injecting, a fuel, an introduction volume of the fuel, an introduction pressure, a fresh air mass flow, and valve control times for gas exchange valves, in particular intake and exhaust valves, such as in particular a valve opening time and a valve closing time, an internal combustion engine speed and a combination of the aforementioned parameters. Alternatively, or additionally, control device 1—in particular the at least one interface 7, calculation module 9 and optimization module 11—is arranged to use as measured value 15 at least one internal combustion engine output parameter selected from a group consisting of a fuel consumption, an emission quantity, a combustion chamber pressure, and a combination of the aforementioned parameters.

Control device 1 is arranged in particular to operate internal combustion engine 3. Optionally, control device 1 is arranged to operate internal combustion engine 3 at an operating measurement point 13 as the measurement point. Alternatively, or additionally, control device 1 is arranged in particular to operate internal combustion engine 3 with new measurement point 21.

Control device 1 is also optionally arranged to iteratively adapt internal combustion engine model 17 based on new measurement point 21 and to determine a further new measurement point 21 in the parameter space.

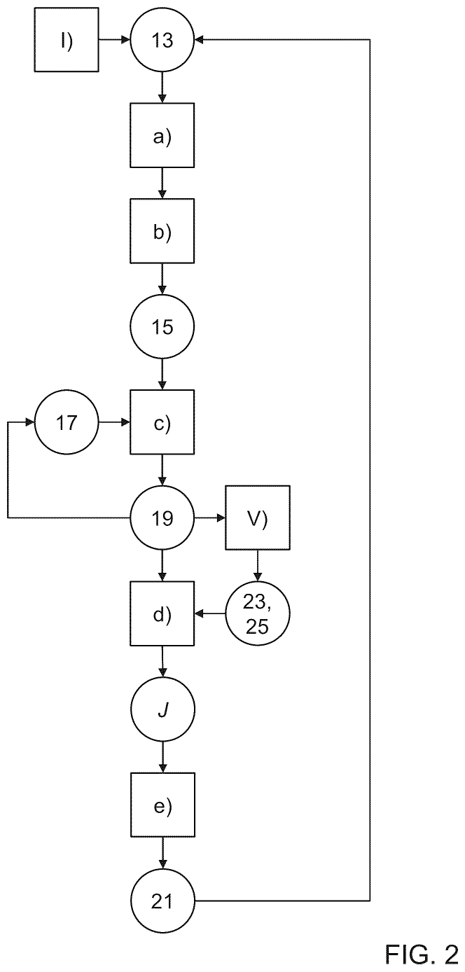

FIG. 2 is a schematic representation of a design example of a method for measuring internal combustion engine 3 on test bench 5, wherein in particular control device 1 according to FIG. 1 is used to implement the method.

In a first step a), internal combustion engine 3 is operated and measured at an operating measurement point 13. In particular, at least one internal combustion engine input parameter spanning the parameter space of the internal combustion engine is used as operating measurement point 13, which is selected from a group consisting of an introduction time for introducing, in particular atomizing or injecting a fuel, an introduction quantity of the fuel, an introduction pressure, a fresh air mass flow, and valve timing for gas exchange valves, in particular intake and exhaust valves, such as in particular a valve opening time and a valve closing time, an internal combustion engine speed, and a combination of the aforementioned parameters.

In a second step b), a measured value 15 is obtained. In particular, at least one internal combustion engine output parameter selected from a group consisting of fuel consumption, emission quantity, combustion chamber pressure, and a combination of the previous parameters is used as measured value 15.

In a third step c), an internal combustion engine model 17 is adapted based on measured value 15 at operating measurement point 13, whereby an adapted internal combustion engine model 19 is obtained. In particular, adapted internal combustion engine model 19 is established as internal combustion engine model 17. In particular, a Gaussian process model is used as internal combustion engine model 17 and in particular as adapted internal combustion engine model 19. In particular, fuel consumption distribution 23 and/or emissions distribution 25 are determined using internal combustion engine model 17 and in particular using adapted internal combustion engine model 19. In particular, the fuel consumption expected value and the fuel consumption variance of the fuel consumption distribution are determined using internal combustion engine model 17 and in particular using adapted internal combustion engine model 19. Alternatively, or additionally, the expected emission value and the emission variance of emission distribution 25 are determined in particular by internal combustion engine model 17 and in particular by way of adapted internal combustion engine model 19.

In a fourth step d) a time function J is determined by way of adapted internal combustion engine model 19. In particular, target function J is determined depending on the fuel consumption distribution and/or the emission distribution. In particular, target function J is established in formula

$$J = {J}_{V}$$

wherein J_{V} denotes a fuel consumption target function. In particular, fuel consumption target function J_{V} is determined using one of the equations (5) to (7). Alternatively, or additionally, target function J is established in formula

$$J = {J}_{E}$$

wherein J_{E} denotes an emission target function. In particular, the emission target function J_{E} is determined by using one of the equations (8) to (10). Alternatively, or additionally, target function J is determined using one of the equations (11) to (13).

In a fifth step e), target function J is optimized, wherein a new measurement point 21 is obtained based on optimized target function J. In particular, target function J is optimized by considering at least one secondary condition. The at least one secondary condition is determined based on at least one parameter selected from a group consisting of a combustion chamber pressure, a combustion chamber pressure gradient, a compressor surge, a soot formation, and a combination of the aforementioned parameters. The secondary condition is optionally determined based on a combustion chamber pressure. In particular, the secondary condition is determined in formula

$$P ( {p}_{max} > {p}_{max}^{max} ) < {p}^{*}$$

wherein, P(⋅) denotes a target function, pₘₐₓ denotes a combustion chamber pressure maximum occurring during a combustion process,

$${p}_{max}^{max}$$

denotes a maximum permissible combustion chamber pressure, and p*denotes a predetermined limiting probability. In particular, the predetermined probability is specified as p*=0.25.

Steps a) to e) are optionally repeated using new measurement point 21 as operational measurement point 13 until a termination condition is reached. In particular, the termination criterion used is when a maximum number of new measurement points 21 is reached. In particular, steps a) to e) are repeated with respective new measurement point 21 as operational measurement point 13 until the maximum number of new measurement points 21 is reached. Alternatively, or additionally, a predetermined measurement point density is used as the termination criterion, wherein in particular steps a) to e) are repeated with respective new measurement point 21 as operational measurement point 13 until the predetermined measurement point density is reached. Alternatively, or additionally, a minimum measurement point distance is used as the termination criterion, wherein, in particular, steps a) to e) are repeated with respective new measurement point 21 as the operating measurement point 13 until a distance, in particular a Euclidean distance, between new measurement point 21 and any of the other measurement points 21 is less than the minimum measurement point distance. Alternatively, or additionally, a maximum variance is used as the termination criterion, wherein, in particular, steps a) to e) are repeated with respective new measurement point 21 as operating measurement point 13 until the variance of internal combustion engine model 17, 19 designed as a Gaussian process model is smaller than the maximum variance.

In an optional initial step 1), initial operational measurement point 13 is specified and/or determined by using a measurement plan according to the state of the art. Starting from the initial operational measurement point 13, steps a) to e) are then performed, particularly iteratively, until the termination condition is reached.

In one optional distribution determination step V), a fuel consumption distribution 23 and/or an emission distribution 25 is determined based on adapted internal combustion engine model 19.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A control device for measuring an internal combustion engine on a test bench, the control device comprising:
at least one interface, which is configured to receive a measured value measured at a measurement point of a parameter space of the internal combustion engine, spanned by at least one internal combustion engine parameter;
a computing module, which is configured to adapt an internal combustion engine model based on the measured value—which is received—at the measurement point; and
an optimization module, which is configured to determine a target function based on an adapted internal combustion engine model, to optimize the target function, and based on the target function—which is optimized—to determine a new measurement point in the parameter space.

2. The control device according to claim 1, wherein the computing module is configured to use a Gaussian process model as the internal combustion engine model.

3. The control device according to claim 1, wherein the computing module is configured to determine at least one of a fuel consumption distribution and an emissions distribution.

4. The control device according to claim 3, wherein the optimization module is configured to determine the target function based on at least one of the fuel consumption distribution and the emissions distribution.

5. The control device according to claim 1, wherein the optimization module is configured to optimize the target function by considering at least one secondary condition.

6. The control device according to claim 5, wherein optimization module is configured to determine the at least one secondary condition based on at least one parameter selected from a group consisting of (i) a combustion chamber pressure, (ii) a combustion chamber pressure gradient, (iii) a compressor surge, (iv) a soot formation, and (v) a combination of at least two of (i), (ii), (iii), (iv), and (v).

7. A method for measuring an internal combustion engine on a test bench, the method comprising the steps of:
(a) operating, and measuring, the internal combustion engine at an operating measurement point;
(b) obtaining a measured value;
(c) adapting an internal combustion engine model based on the measured value;
(d) determining a target function based on the internal combustion engine model which is adapted; and
(e) optimizing the target function, wherein a new measurement point is obtained based on the target function that is optimized.

8. Method according to claim 7, further comprising the step of (f) repeating steps (a) to (e) with the new measurement point as the operating measurement point until a termination condition is reached.

9. The method according to claim 7, wherein the target function is determined depending on at least one of a fuel consumption distribution and on an emissions distribution.

10. The method according to claim 7, wherein the target function is optimized by considering at least one secondary condition, wherein the at least one secondary condition is determined based on at least one parameter selected from a group consisting of (i) a combustion chamber pressure, (ii) a combustion chamber pressure gradient, (iii) a compressor surge, (iv) a soot formation, and (v) a combination of at least two of (i), (ii), (iii), (iv), and (v).

11. The method according to claim 7, further comprising the step of (f) repeating steps (a) to (e) with the new measurement point as the operating measurement point until a termination condition is reached, wherein reaching a maximum number of a plurality of the new measurement point is used as the termination condition.

12. The method according to claim 11, wherein steps (a) to (e) are repeated with a respective one of the new measurement point as the operating measurement point until the maximum number of the plurality of the new measurement point is reached.
